(19) United States
(12) Patent Application Publication
(10) Pub. No.: US 2014/0073349 A1
(43) Pub. Date: Mar. 13, 2014

(54) Location-Dependent Selection of a Radio-Based Localization Method for a Mobile Terminal

(71) Applicant: Thorsten Schunk, Bruggen (DE)

(72) Inventor: Thorsten Schunk, Bruggen (DE)

(73) Assignee: VODAFONE HOLDING GMBH, Dusseldorf (DE)

(21) Appl. No.: 14/007,372

(22) PCT Filed: Mar. 26, 2012
(86) PCT No.: PCT/EP2012/055347

§ 371 Date: Nov. 26, 2013

(30) Foreign Application Priority Data
Mar. 25, 2011 (DE) 10 2011 006 180.0

(51) Int. Cl. H04W 64/00

(52) U.S. Cl. CPC H04W 64/003
USPC 455/456.1

(57) ABSTRACT

The techniques described herein relate to a method for the localization of a terminal device by a localization unit that is configured to locate the terminal device on the basis of radio signals received in the terminal device from radio access points. In the method, the activation of the localization is controlled on the basis of the radio signals as a function of an evaluation of radio signals from at least one radio access point that have been detected in the vicinity of the terminal device by at least one receiving unit, and/or as a function of information about installation sites of radio access points. Moreover, the techniques described herein relate to a system that is suitable for carrying out the method.

### CROSS REFERENCE TO RELATED APPLICATION

Pursuant to 35 U.S.C. Pursuant to 35 U.S.C. §371, this application is the United States National Stage Application of International Patent Application No. PTC/EP2012/022347, filed on Mar. 26, 2012, the contents of which are incorporated by reference as if set forth in their entirety herein, which claims priority to German (DE) Patent Application No. 102011006180.0, filed Mar. 25, 2011, the contents of which are incorporated by reference as if set forth in their entirety herein.

### BACKGROUND

A number of radio-based measuring methods are known for the localization of mobile terminal devices such as, for example, smartphones, notebook computers and other mobile communication terminal devices, and these measuring methods can determine the approximate position of a terminal device on the basis of received radio signals. Such methods include localization by a Satellite-Assisted GPS (Global Positioning System) or similar satellite navigation systems. The satellite-assisted localization can be augmented by taking additional information into account. An example of this is information about the cell of a cellular mobile radio network in which the terminal device that is to be located is currently present. When the GPS is augmented by adding such information, this is also referred to as Assisted GPS (A-GPS). Moreover, signals received in the terminal devices from access points to radio networks can be used for localization purposes. Some methods use the base stations of mobile radio networks as access points. Other methods use radio signals from Wi-Fi or WLAN (Wireless Local Area Network) access points in order to locate terminal devices (the terms Wi-Fi and WLAN are used here synonymously).

In comparison to localization via satellite navigation systems, if there is adequate WLAN coverage of the area where the terminal device that is to be located is present, Wi-Fi-based methods have the advantage that localization is also possible inside buildings, especially department stores, shopping malls, convention centers, airports and the like, where the signals from satellite navigation systems often cannot be received. Moreover, the position of the terminal device, especially in densely built-up areas with poor reception conditions for satellite signals, can often be determined more accurately than by a GPS or A-GPS.

Consequently, Wi-Fi-based localization is fundamentally useful to localization by a satellite navigation system, especially GPS. Wi-Fi-based localization, however, requires a certain density of Wi-Fi access points, and this is not the case everywhere. In particular, the terminal device that is to be located, as a rule, has to receive radio signals from a given minimum number of radio access points in order for the localization to be sufficiently precise.

Several methods are available for Wi-Fi-based localization which, depending on the reception situation of the terminal device, allow localization with varying levels of precision.

A first such Wi-Fi-based localization method is based on lateration. Here, the position of the terminal device is determined as the intersection of three circles in each of whose mid-points there in an access point and whose radii correspond to the distance to the access point. For this purpose, the positions of the access points are determined in advance and they serve as input quantities for the lateration. One possibility for determining the distances to the access points is offered by the so-called RSS (Received Signal Strength) methods in which the distance to an access point is determined on the basis of the strength of a signal from the access point that has been received by the terminal device, taking into account the transmit power of the access point.

Such lateration calls for the reception of radio signals from at least three Wi-Fi radio access points and it accounts for a high level of precision, especially when the radio signals from the radio access points can propagate largely unimpeded. As a rule, attenuation and other interferences due to obstructions cannot be taken into account during the localization, as a result of which they lead to a greater imprecision of the determined position.

So-called pattern recognition methods can be employed as additional Wi-Fi-based localization methods. The basis of these methods is that a received radio signal pattern containing the signal strengths of the received Wi-Fi signals—also referred to as the fingerprint—is compared to reference signal patterns that have been detected in advance. In the case of the pattern recognition methods, the place where the reference pattern having the greatest correspondence with the detected fingerprint was measured is the place that can be assumed as being the position of the terminal device, or else the position is determined on the basis of several reference patterns having a great degree of correspondence as well as on the basis of the associated positions, as a result of which positions of the terminal device between the detection sites of the reference patterns can be determined as locations.

The precision of the localization on the basis of pattern recognition increases with the number of radio access points whose radio signals are received in the terminal device to be located and which are used for the localization, since the signal patterns in different positions differ from each other to a greater extent when there is a larger number of different radio signals. Moreover, interferences during the signal propagation lead to greater “individuation” of the signal patterns at a given position. Consequently, pattern recognition is especially well-suited for the localization of terminal devices whenever lateration would result in greater imprecision.

Moreover, the location of a terminal device can be determined on the basis of the position of a radio access point whose radio signals are received in the terminal device or else which receives radio signals from the terminal device. In this case, however, this merely makes it possible to determine an area in which the terminal device is present and which corresponds to the transmitting and receiving area of the appertaining radio access point. The precision is thus considerably less than in the case of localization by lateration or pattern recognition. However, if only radio signals from one single radio access point are received or if radio signals from the terminal device are only received in one radio access point, and if other localization methods such as, for instance, GPS are not available, then the position of a terminal device can be determined only on the basis of such an approximation.

Therefore, different methods for radio network-based localization of mobile terminal devices can be used whose precision varies in different situations. Whether or not radio network-based localization can be carried out and which localization method is to be selected depends on the circumstances at the position of a terminal device that is to be located, especially on the local density of the radio access points as well as on any interferences in the signal propagation that might exist.

### SUMMARY

The techniques described herein relate to the radio-based localization of terminal devices. In particular, the techniques described herein relate to a method and to a system for the localization of a terminal device.

Before this backdrop, it is an objective of the present innovation to be able to make a targeted selection of a suitable radio network-based localization method in cases when a radio network-based localization can be carried out.

According to one embodiment, a method for the localization of a terminal device by a localization unit is put forward. The localization unit is configured to locate the terminal device in a radio network based manner, on the basis of radio signals sent and/or received in a radio network. With this method, the activation of the localization is controlled on the basis of the radio signals as a function of an evaluation of radio signals from at least one radio access point of the radio network that have been detected in the vicinity of the terminal device by at least one receiving unit, and/or as a function of information about installation sites of radio access points of the radio network. The Vicinity is determined in such a way that it surrounds a position of the terminal device that has previously been determined at least by approximation. This position that has been determined by approximation is ascertained by a central unit that can be connected to the terminal device and/or to the radio access point, based on an identifier of a radio access point situated within the radio range of the terminal device.

According to another aspect, the techniques described herein propose a system for the localization of a terminal device. This system comprises a localization unit that is configured to locate the terminal device on the basis of radio signals sent and/or received in a radio network. In this system, the activation of the localization can be controlled on the basis of the radio signals as a function of an evaluation of radio signals from at least one radio access point of the radio network that have been detected in the vicinity of the terminal device by at least one receiving unit, and/or as a function of information about installation sites of radio access points of the radio network. Moreover, the availability and expected precision of the localization can already be estimated in advance on the basis of the radio signals for a specific position of the terminal device that is to be located, that is to say, before the position is reached.

Advantageously, the techniques described herein allow the activation of a radio network-based localization to be controlled as a function of information that can be evaluated in addition to the radio signals that are received in the terminal device. In this manner, information can be used that is not available in the terminal device and that might allow a better evaluation of the availability and achievable precision of the radio network-based localization. By this control, the radio network-based localization can especially be activated, or else it can be deactivated, especially if inadequate availability of such a localization is ascertained.

In one embodiment, the radio access points are configured as Wi-Fi access points that especially operate according to a standard of the IEEE 802.11 family. The radio access points can be operated, for example, by the customers of a data service provider that is accessed via the radio access points in their residences or at their business premises. By the same token, these can be, for example, radio access points that are operated in public places. In another embodiment, these are radio access points of a mobile radio network, especially a 2G, 3G or 4G network. These can especially also be radio access points that generate so-called micro or pico radio cells that have a relatively small spatial dimension. Such as radio access points can be operated, among other things, like Wi-Fi access points in residential or business premises, or else locally in certain public places that otherwise do not have sufficient coverage by a mobile radio network. However the techniques described herein are not limited to such micro or pico radio cells, but rather, fundamentally any radio access points of mobile radio networks can be used.

The Radio signals transmitted and/or received in the radio network are especially radio signals that are transmitted by a radio access point of the radio network and received in the terminal device, and/or they are radio signals that are transmitted by the terminal device and received in a radio access point of the radio network.

The receiving unit is operated independently of the terminal devices. In particular, it can be essentially stationary receiving unit that is installed and operated at an installation site.

In one embodiment of the method and of the system, it is provided that the localization in a radio network-based manner by the localization unit is only activated or continued if the number of radio access points whose radio signals are detected in the receiving unit and/or the number of radio access points with an installation site in the vicinity of the terminal device exceeds a prescribed minimum number. Otherwise, the localization is deactivated. The term “continue” refers here to retaining the activation of the localization. In the above-mentioned embodiment, the activation or the continuation of the activation is advantageously made to depend on the number of radio access points whose radio signals can be received in the area of the position of the terminal device that is to be located. It can be provided that the localization by the radio signals from the radio access points is activated or continued if the receiving unit can only receive radio signals from a single radio access point, and/or if only one radio access point is present in the vicinity of the terminal device. In this case, however, the terminal device can only be located with less precision on the basis of the radio signals. Therefore, the minimum number of radio access points that can be received by the receiving unit and/or that are positioned in the vicinity of the terminal device can be set at two or more in order to activate or continue the localization on the basis of the radio signals. In this case, due to the higher number of receivable radio access points, that is to say, of radio access points whose radio signals can be received, a greater precision of the localization can be expected.

Moreover, one embodiment of the method and of the system provides that, on the basis of the evaluation of the radio signals, the number of radio access points is estimated whose radio signals can be received at a future position of the terminal device. Therefore, the availability of a localization can be ascertained on the basis of the radio signals from the radio access points at a future position of the terminal device at which the terminal device might arrive based on a previously determined position.

In particular, the future availability of the localization can thus be ascertained on the basis of the radio signals from the radio access points when the terminal device is moving. In this context, in one embodiment of the method and of the system, the direction of movement of the terminal device is ascertained, and the vicinity is determined as a function of the ascertained direction of movement of the terminal device. On the basis of the ascertained direction of movement, for instance, the above-mentioned future position of the terminal device can be determined or estimated.

A refinement of the method and of the system is characterized in that the radio signals are detected in the receiving unit and evaluated on the basis of an evaluation that is to be performed. Such an evaluation of radio signals that is performed on an as-needed basis can ensure, among other things, that the evaluated information is up to date. As an alternative, however, it can also be provided that a regular detection of the radio signals is carried out and that their results are stored, for example, in a database.

Furthermore, one embodiment of the method and of the system provides that, in order to locate the terminal device, the radio access points whose radio signals can be received in the terminal device are determined by a radio adapter of the terminal device, and that the determination of such radio access points by the radio adapter is deactivated if the localization by the radio signals has not been activated or continued, that is to say, it has been deactivated. Beyond this scanning, the radio adapter can also be switched off entirely if it is not needed, for instance, to maintain a data connection to a radio access point. By switching off the radio adapter or at least by switching off the determination of receivable radio access points, energy can be saved and the charge of the battery that supplies the terminal device with power can be prolonged.

Furthermore, one embodiment of the method and of the system provides that several localization methods for the localization of the terminal device can be performed in the localization unit on the basis of the received radio signals, and that the performed localization method is selected as a function of an evaluation of the radio signals from at least one radio access point that have been detected by the receiving unit. In this manner, on the basis of an evaluation of the radio signals that have been detected outside of the terminal device, the localization method can be selected that is best suited at a given position for locating the terminal device, and especially that translates into the greatest possible localization precision.

The localization methods comprise a lateration in which the distances to radio access points are determined on the basis of the signal strength of radio signals received in the terminal device from the radio access points, and they comprise a localization on the basis of pattern recognition or a pattern evaluation procedure in which comparisons are made between the detected signal pattern and reference signal patterns. As already explained above, a high degree of localization precision can be achieved by lateration if the radio signals from the radio access points taken into consideration for the localization can propagate largely unimpeded, since only in this case can the distances to the radio access points be determined with sufficient reliability on the basis of the received signal strengths. In contrast, if the signal propagation is impeded, the localization by a pattern evaluation yields a greater precision.

In one embodiment of the method and of the system, it is provided that the evaluation of the radio signals from a radio access point that have been received by the receiving unit comprises a comparison of the signal strength received in the receiving unit to the signal strength that is expected on the basis of the transmit power of the radio access point. Moreover, the known positions of the receiving unit and of the radio access point are used in order to determine the expected transmit power.

The expected signal strength is especially an estimated value for the signal strength that would result at the position of the detection unit in case of an essentially unimpeded signal propagation. Therefore, on the basis of the comparison to the measured signal strength, it can be ascertained whether it can be assumed that the signal propagation is largely unimpeded and that a localization by lateration can be carried out with high precision, or whether instead, the signal propagation is impeded and a localization can be carried out with high precision on the basis of pattern evaluation. Therefore, one embodiment of the method and of the system provides that a localization by lateration is carried out when a deviation between the detected signal strength and the expected signal strength does not exceed a prescribed threshold value. Otherwise, the localization is carried out on the basis of pattern recognition.

Furthermore, one embodiment of the method and of the system is characterized in that the transmit power of the radio access point is determined on the basis of the transmit power data that is representative of the transmit power and that is reported by the radio access point. Advantageously, in this embodiment, the transmit power needed for the evaluation explained above, which as a rule cannot be determined in another manner, is reported by the radio access point itself.

Moreover, one refinement of the method and of the system is characterized in that at least one receiving unit is a first radio access point, whereby the first radio access point can be operated in a first mode of operation in which it serves as the access point to a communication network, and in that the first radio access point can be operated in a second mode of operation in which radio signals from other radio access points can be detected. Advantageously, in this refinement, the radio access points can be used as receiving unit. As a rule, the radio access points are essentially located permanently at the detection site, so that an evaluation can be carried out on the basis of continuous up-to-date information.

The above-mentioned and additional advantages, special features and practical refinements of the techniques described herein are also explained on the basis of embodiments, which are described below with reference to the figures.

### BRIEF DESCRIPTION OF THE DRAWINGS

FIG. 1 a schematic depiction of a system for the localization of terminal devices on the basis of radio signals from radio access points and

FIG. 2 a schematic illustration of a connection of the radio access points shown in FIG. 1 to a service provider network and a wide area network, as well as a central unit for providing localization information.

### DETAILED DESCRIPTION OF SPECIFIC EMBODIMENTS

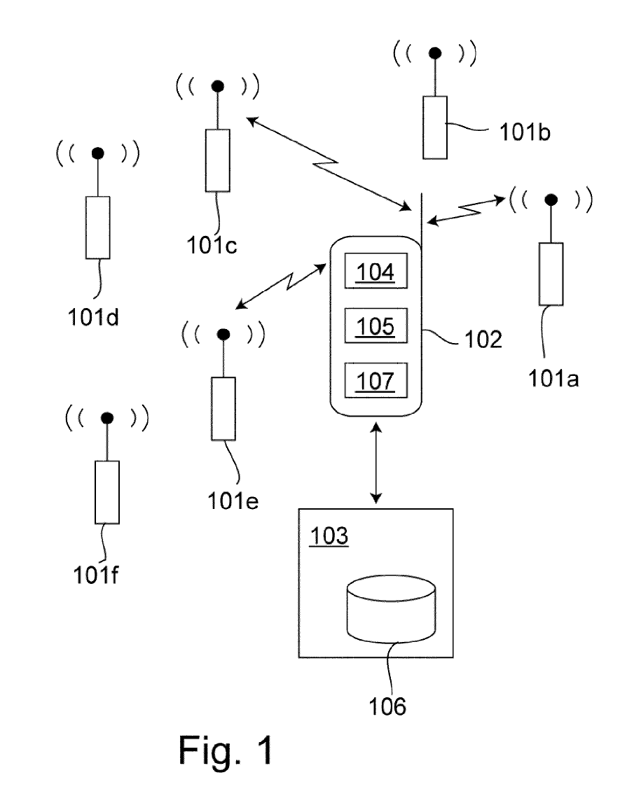

FIG. 1 schematically shows a number of radio access points 101i (in FIG. 1 by way of example i=a, . . . , f) in an area where mobile terminal devices 102—one of which is illustrated by way of an example in FIG. 1—can be located by measuring the signals from the radio access points 101i. In one embodiment, the radio access points 101i are Wi-Fi-capable or WLAN-capable access points 101i that operate according to a standard of the IEEE 802.11 family. The radio access points 101i can be operated, for example, in the residences or at the business premises of customers of a provider of data service that can be accessed via the radio access points 101i. As an alternative or in addition, the system shown in FIG. 1 can comprise radio access points 101i that are operated in public places, for example, in shopping arcades, train stations, airports, convention centers, cafés or the like.

At a position that is to be located by a Wi-Fi-based localization method, a mobile terminal device 102, like at a position that is to be located, receives radio signals from some of the radio access points 101i, and these signals are evaluated for localization purposes. In addition to the radio signals from the radio access points 101i, localization information that is provided by a central unit 103 is also employed for localization purposes. The terminal device 102 that is to be located is connected to the central unit 103 in a suitable manner. The connection can be established, for example, via one of the radio access points 101i or via a mobile radio network (not shown in the figure) into which the mobile terminal device 102 has logged in.

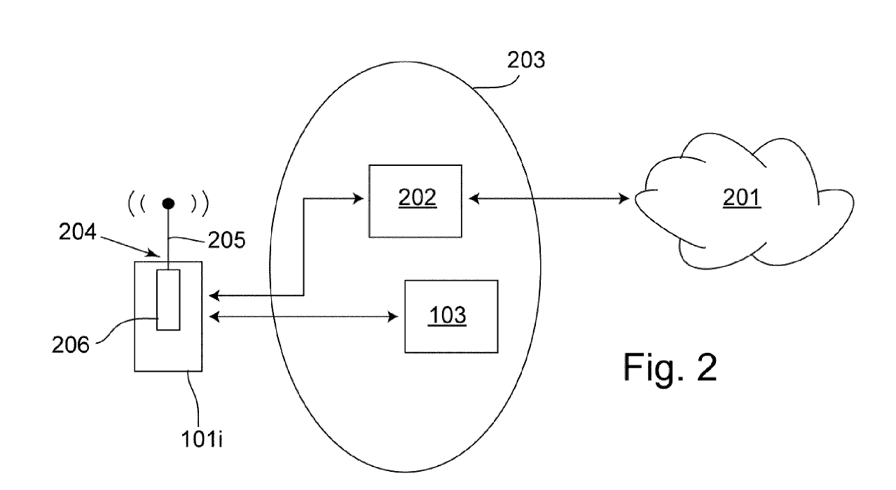

As the schematic depiction of FIG. 2 illustrates for an example of a radio access point 101i, terminal devices 102 that are connected to the radio access points 101i can access a wide area network (WAN) 201, especially the Internet, via the radio access points 101i. Data connections to the wide area network 201 are established via an access server 202 that is operated by the data service provider for access to the wide area network and that is located in a service provider network 203 that is connected to the wide area network 201. Here, the radio access points 101i can be connected to the wide area network 201 via a service provider network 203. Fundamentally, however, it is likewise possible for the radio access points 101i to be connected to the wide area network 201 via several different service provider networks 203, which can also be operated by several different service providers.

As shown in FIG. 2 by way of an example of one of the radio access points 101i, the radio access points 101i have a radio interface 204 with an antenna 205 for transmitting and receiving radio signals as well as a control unit 206 for controlling the data transmission via the antenna. The radio access points 101i are connected to the service provider network 203 via a landline. The data transmission can take place, for example, via a DSL (Digital Subscriber Line) connection. In this case, a DSL modem is integrated into the radio access point 101i, or else the radio access point 101i is connected to such a DSL modem with which the service provider network 203 is accessed via a DSLAM (DSL Access Multiplexer). By the same token, however, other transmission technologies can also be used. For example, the service provider of the data service and the operators of the service provider network 203 can make the radio access points 101i available to their customers. Likewise, operators can, of course, also obtain the radio access points 101i in another manner.

For purposes of Wi-Fi-based localization of the terminal devices 102, beacon signals from the radio access points 101i are used that are transmitted by the radio access points 101i at regular time intervals. The beacon signals each contain an unambiguous identifier of the transmitting radio access point. In this context, this can be a BSSID (Basic Service Set Identification) that corresponds to an unambiguous MAC (Media Access Control) address of the access point. The identifier can also be read out of the radio signal by a terminal device 102, even if the terminal device 102 is not logged in at the radio access point 101i, that is to say, even if the terminal device 102 is not using the radio access point 101i for data exchange with the wide area network 201 or with the service provider network 203. In particular, a terminal device 102 can read out the identifier, even if a protected radio access point 101i is involved in which the access possibility is limited to specially authorized users—for example, through the use of a password and/or special terminal device filters such as MAC filters—and the terminal device 102 does not have authorization to gain access.

The terminal devices 102 that can be located in the system can be configured, for example, as mobile phones, smartphones, tablet PCs, notebook computers or the like. For communication with the radio access points 101i, the terminal devices 102 have radio adapters 104 with which radio signals from the radio access points 101i can be received, and with which radio signals can also be transmitted to the radio access points 101i. In order to evaluate the beacon signals, the radio adapter 104 has a unit for reading out the contained identifier. Moreover, the radio adapter 104 is configured to determine the signal strength of the radio signals received from the radio access points 101i, especially the received beacon signals. In addition to the radio adapter 104 for establishing connections to the radio access points 101i, the terminal devices 102 can also contain other communication interfaces for mobile data exchange such as, for instance, radio modules for connection to a mobile radio network, which is not shown in the figures. In this manner, the terminal devices 102 can also connect to devices in the wide area network 201 or in the service provider network 203 via one of the radio access points 101i, without using a data connection, for example, even if they are not authorized to use the available radio access points 101i.

The system shown in FIG. 1 also comprises a central unit 103 to provide localization information that is employed to locate terminal devices 102 on the basis of the radio signals from the radio access points 101i. In the embodiment shown, the central unit 103 is operated by the provider of the data service in the service provider network 203, so that this service provider can also offer a localization service in addition to the data service. By the same token, however, it can also be provided that the data service and the localization service are offered by different service providers. The localization information is contained in a database 106 of the central unit 103 which is accessed in order to locate a given terminal device 102. During the localization of the terminal device 102, data is exchanged between the terminal device 102 and the central unit 103. For this purpose, as mentioned above, the terminal device 102 can communicate for example, via one of the radio access points 101i, with the central unit 103 or else via another modality of communication such as, for instance, via a mobile radio network (not shown in the figures). As already mentioned, this modality of communication can be used, even if the terminal device 102 is not connected to any of the radio access points 101i or cannot connect to any of the radio access points 101i.

The Wi-Fi-based localization of a terminal device 102 is carried out by a localization unit 105 that, in the embodiment shown in FIG. 1, is arranged in the terminal device 102 and that can be configured, for example, as software that runs in a processor of the terminal device 102. In this embodiment, the received identifiers of radio access points 101i as well as the measured signal strengths are transferred within the terminal device 102. Additional localization information is transmitted from the central unit 103 to the localization unit 105 in the terminal device 102. This is done, for example, as a result of an applicable request from the terminal device 102. The selection of the data in the central unit that is to be transmitted to the localization unit 105 is made, for instance, on the basis of the identifiers that are received in the terminal device 102 and that can be transmitted from the terminal device 102 to the central unit 103 so that the selection can be made. In an alternative embodiment, the localization unit 105 can also be arranged in the central unit 103. In this manner, the localization can be carried out, even if the terminal device 102 has limited computing capabilities. In this embodiment, the terminal device 102 transmits the received identifiers of the radio access points 101i as well as the measured signal strengths to the central unit 103, together with a localization request. There, the localization unit 105 computes the position of the terminal device 102 in the manner described above, and reports this back to the terminal device 102.

In one embodiment, the localization of the terminal device 102 is carried out by a pattern recognition method. Here, the signal strengths of the radio signals, especially of the beacon signals—also referred to as RSS values—that have been transmitted by the radio access points 101i are determined in the terminal device 102 and the associated identifiers of the radio access points 101i are read out from the signals. The composition of the RSS values is also referred to here as the signal pattern. For purposes of locating the terminal device 102, a localization unit 105 compares the received signal pattern to reference signal patterns that are provided by the central unit 103. Each of the reference signal patterns is associated with a position where the reference signal pattern was detected. Then the localization unit 105 determines the approximate position of the terminal device 102 on the basis of a comparison between the detected signal pattern and the reference signal patterns. Various methods that are generally known to the person skilled in the art can be used for this purpose. Examples of such methods are Nearest Neighbors in Signal Space (NNSS) methods in which the position is determined on the basis of the Euclidean distance between an RSS vector containing the acquired RSS values and the RSS vectors containing the signal strengths of the reference signal patterns. In particular, as an estimate of the position of the terminal device 102, the position can be determined that is associated with the reference RSS vector with the smallest Euclidean distance to the acquired RSS vector. Additional examples are so-called k-NNSS methods in which, instead of one single reference pattern with an RSS vector with the smallest Euclidean distance to the acquired reference value, several reference patterns for adjacent positions—especially k adjacent positions—are included in the position determination, as well as so-called smallest polygon methods.

The reference signal patterns and the identifiers of the radio access points from which radio signals are received and whose signal strengths are contained in the patterns are detected at known positions by one or more receiving unit, and these can be stored, together with the positions, in a database 106 of the central unit 103. In one embodiment, measuring vehicles with which measuring drives are carried out are used as the receiving unit. During the measuring drives, the measuring vehicles record the signal strengths of received radio signals, the associated identifiers of the radio access points 101i that are transmitting the radio signals, as well as the associated positions. The positions can be determined, for example, in the measuring vehicles by GPS. The execution of such measuring drives is also known by the term wardriving, and it is repeated as often as possible in an area so that the most up-to-date data record possible can be provided.

In another embodiment, in order to detect the reference signal patterns, at least some of the radio access points 101i that can communicate with the central unit 103 are used for this purpose. Such a detection of reference signal patterns is explained below and is also the subject matter of the patent application filed in parallel by the present applicant under the internal file number 12214-PT-DE, to which reference is hereby made.

In order to detect the signal pattern data, the beacon signals from the surrounding radio access points 101i are received by a radio access point 101i and evaluated. For this purpose, the radio access point 101i scans all of the usable radio channels in a manner similar to the communication terminal devices 102 in the search for available radio access points 101i. For purposes of receiving the beacon signals, the radio access point 101i is operated in a client mode. In this mode, the radio interface 204 of the radio access points 101i is used to receive radio signals from other radio access points 101i. This can especially be achieved by appropriately adapted firmware of the radio access point 101i. An example of suitable firmware that can be used in the radio access points 101i of the system in order to allow the detection of radio signal patterns is the generally known free radio firmware for radio access points 101i that is used in so-called free radio networks. In the client mode, a radio access point 101i has functionalities that are also provided by the radio adapters 104 of Wi-Fi-capable terminal devices 102, but this normally does not offer terminal devices 102 the possibility of access to the radio access point 101i in order to establish data connections to the service provider network 203 or to the wide area network 201. Therefore, it is provided that the radio access points 101i are only briefly operated in the client mode in order to detect signal pattern data. For the rest, the radio access points 101i are operated in a “normal” mode of operation in which terminal devices 102 can establish data connections especially to the wide area network 201 via the radio access points 101i.

In one embodiment, it is provided that the radio access points 101i detect the radio signal patterns in prescribed, especially regular time intervals and transmit them to the central unit 103. In the central unit 103, in each case, the last of the radio signal patterns transmitted from the radio access points 101i are stored as reference signal patterns in the database 106. In this manner, a data record containing localization information comprising reference signal patterns can be established in the database 106 by using the radio access points 101i. Access will then be made to individual reference signal patterns that are stored in the database 106 whenever a localization of a terminal device 102 is to be carried out. Here, for a localization procedure, for example, the reference signal patterns can be used that contain one or more identifiers of a radio access point 101i, which have also been acquired by the terminal device 102 at the position that is to be located, and/or the reference signal patterns stored in the database 106 can be used that were reported by a radio access point 101i whose identifier is acquired by the terminal device 102 at the position that is to be located. The identifier is indicated by the radio access point 101i when the signal pattern data is transmitted to the central unit 103, and it can be stored in the database 106 together with the signal pattern data.

In another embodiment, in addition to or as an alternative to continuous updates in the database 106 of the signal pattern data acquired by a radio access point 101i, it is provided that the radio access points 101i report the signal pattern data to the central unit 103 on an as-needed basis when a terminal device 102 is to be located. For this purpose, if needed, the central unit 103 can request the signal pattern data from a radio access point 101i which then, in a response to the request, transmits the data to the central unit 103 that provides the signal pattern data in the manner already described above for the localization unit 105 that performs the localization. The request for the transmission of the signal pattern data is sent by the central unit 103, to the radio access point 101i whose signal pattern data is potentially relevant for the localization that is to be carried out. This data can be, for example, the radio access points whose identifiers are received by the terminal device 102 that is to be located and/or radio access points that receive radio signals from other radio access points 101i whose identifiers are received by the terminal device 102 that is to be located. These identifiers can be determined by the radio access points 101i, for example, regularly by scans, and reported to the central unit 103. By the same token, the central unit 103 can determine the reference signal patterns that are relevant for the localization in another manner, for instance, on the basis of an estimated position of the terminal device 102 and on the basis of the positions of the radio access points 101i.

In the previously described embodiment, the positions where the reference signal patterns are detected and which are likewise needed for the localization of terminal devices 102 correspond to each of the positions of the radio access points 101i that report the reference signal patterns. In the system shown in FIG. 1, the positions of the access points 101i are stored in the database 106 of the central unit 103, together with the identifier and, if applicable, together with the reference signal pattern data or transmit power information (if this is permanently stored and not requested for each localization) that has been reported by the access points. When a terminal device 102 is to be located, the positions of the radio access points 101i taken into consideration for the localization are read out of the database 106 and transmitted to the localization unit 105, which carries out the localization.

The positions of the radio access points 101i can be detected in various ways. In one embodiment, the positions are indicated, for example, by the users or operators of the radio access points 101i. In particular, the positions can be determined from addresses of the installation sites that are indicated by the users. These can match, for example, the addresses of the residences or business premises of the users who indicate these to the service provider of the data service, before the radio access points 101i they operate are used to locate the terminal devices 102. The information can be provided in conjunction with the localization service of the service provider. However, it can also be provided that the information is given when the customer registers with the data service. As an alternative, the positions can also be acquired by the service provider of the localization service when the radio access points 101i are set up if the radio access points 101i are set up by the service provider. This can be the case, for instance, with publicly accessible radio access points 101i that are operated by the service provider, as well as with radio access points 101i of private persons and companies that make use of a service of the service provider for setting up the radio access points 101i. However, other variants for detecting the positions of the radio access points 101i can also be implemented if these would prove to be more practical. In order to determine the positions of the radio access points 101i on the basis of the addresses of the installation sites, geocoding of the kind generally known to the person skilled in the art is used, in which the coordinates of the addresses are determined in a suitable coordinate system.

The positions of the radio access points 101i are transmitted to the localization unit 105 that carries out the localization of a terminal device 102, in each case, together with the reference signal patterns that are employed in the localization unit 105 for purposes of the localization.

In another embodiment, instead of using measuring vehicles or the radio access points 101i, it is also fundamentally possible to use special stationary measuring devices that are installed in known positions and that are connected to the central unit 103.

As an alternative to the localization by pattern recognition, the localization unit 105 can also perform a lateration of the kind fundamentally known to the person skilled in the art in order to estimate the position of the terminal device 102. The prerequisite for the lateration is that radio signals must be received from at least three different radio access points 101i in the terminal device 102 that is to be located. Within the scope of the lateration, the position of the terminal device 102 is ascertained approximately as the intersection of three circles whose mid-points each contain a radio access point 101i whose radio signals are received in the terminal device 102. The radii of the circles each correspond to the distance between the terminal device 102 and the associated radio access point 101i.

In order to estimate the position of the terminal device 102 on the basis of lateration, the terminal device 102 determines the identifiers of at least three radio access points 101i whose radio signals are received in the terminal device 102. The central unit 103 then provides the localization unit 105 with the positions of the radio access points 101i that can be stored in the database 106, for example, together with the associated identifiers. If radio signals from more that three radio access points 101i have been detected in the terminal device 102, then it can be provided that three radio access points 101i are selected for the lateration, either randomly or according to a prescribed criterion, and the remaining radio access points 101i are no longer taken into consideration. A useful criterion can stipulate, for example, that only the three radio access points 101i with the highest signal strengths are taken into consideration. The radio access points 101i taken into account for the lateration can already be selected when the radio signals are detected in the terminal device 102, or else in the central unit 103 or in the localization unit 105.

The distances between the terminal device 102 and the radio access points 101i that are to be taken into account as circle radii for the lateration are each determined on the basis of the signal strength of the radio signal, especially the beacon signal, received by the radio access points 101i, and also as a function of the transmit power of the radio access points 101i, which is likewise provided by the central unit 103, as will be explained in greater detail below. In order to determine the distance on the basis of the transmit power and on the basis of the received signal strength, the localization unit 105 can use a prescribed estimated relationship for the drop in the signal strength as a function of the distance to the radio access point 101i. As an approximation, the distance can be determined, for example, under the assumption that the radio signals are propagating in free space. If there are only slight interferences in the signal propagation, resulting, for instance, from obstructions in the signal path, a lateration can thus be carried out in which the precision of the determined position of the terminal device 102 is within a range of 10 meters or better.

In one embodiment, prescribed standard values, corresponding, for instance, to the usual factory default settings of radio access points, can be used as the transmit power. In this manner, however, it is not possible to take into consideration the fact that the factory default setting of the transmit power can normally be changed. In order for such changes to also be taken into account, one embodiment provides that at least some of the radio access points 101i whose radio signals are used in the system described here for the localization of terminal devices 102 transmit to the central unit 103 the transmit power that has been preset in each case. This will be explained below and it is likewise the subject matter of the above-mentioned patent application filed by the present applicant under the internal file number 12214-PT-DE, to which reference is hereby made.

In order to indicate the transmit power of the radio access point 101i, the latter transmits to the central unit 103 the transmit power data in a message together with the identifier of the radio access point 101i. The transmit power data can directly indicate the transmit power or it can contain information from which the central unit 103 can determine the transmit power. Thus, for example, it can be provided that the transmit power at the radio access point 101i can be set as a fraction of a device-specific maximum transmit power. In such a case, the transmit power data can, for example, indicate the fraction that has been set. In addition, the radio access point 101i can indicate the maximum transmit power or else a device name on the basis of which the central unit 103 determines the maximum transmit power of the device from a table. Based on the information obtained, the central unit can then determine the momentary transmit power of the radio access point 101i.

In one embodiment, the radio access point 101i reports to the central system the transmit power on the basis of transmit power data, irrespective of a localization or position determination that is to be carried out for a terminal device 102, and the transmit power, together with the likewise reported identifier of the radio access point 101i, is stored in the database 106 of the central unit 103. When the localization of a terminal device 102 is to be performed on the basis of lateration employing the radio signals from the radio access point 101i, then the transmit power is read out of the database 106 and provided to the localization unit 105 in the manner described above for purposes of the localization.

In order to be able to use the up-to-date transmit power of the radio access point 101i for the position determination, it can be provided that the radio access point 101i reports the transmit power on the basis of applicable transmit power data in prescribed—and in some embodiments regular—time intervals to the central unit 103, and the central unit 103 adapts the database entry containing the transmit power when it ascertains a change in the transmit power as compared to the previously stored value. The regular reports can either be initiated by the radio access point 101i or can be made on the basis of requests that the central unit 103 transmits to the radio access point 101i. If the radio access point 101i supports this, it can also be provided that only reports about changes in the transmit power are transmitted to the central unit 103 and are then used by the central unit 103 in order to update the applicable database entry. An advantage of this embodiment is that, in the central unit 103, the most up-to-date transmit power of the radio access point 101i is always available and the required reports of the radio access point 101i can be reduced.

In another embodiment, the transmit power data is transmitted whenever a terminal device 102 is to be located. For this purpose, the central unit 103 requests the transmit power data from the radio access point 101i when it receives a localization request from a terminal device 102 or a request from a terminal device 102 to provide localization information for a lateration procedure. On the basis of the transmit power data that the radio access point 101i transmits as the response to the request, the central unit 103 determines the transmit power of the radio access point 101i and forwards this to the localization unit 105, which performs the localization procedure.

Along with the transmit power data, the operating status of the associated radio access point 101i, that is to say, whether the radio access point 101i is switched on or off, can also be reported to the central unit 103. In this context, the operating status can be implicitly derived from the transmit power data. In order to inform the central unit 103 about the switching off of the radio access point 101i, it is provided that, at the time of the switch-off procedure, a report is sent to the central unit. In addition or as an alternative, the central unit can mark a radio access point 101i as being switched off if the prescribed regular reports are not received.

The positions of the radio access points 101i, which are likewise needed for the lateration, are stored together with the associated identifier in the database 106 of the central unit 103. In this process, the positions can be detected in the manner described above and then reported to the central unit 103. The positions, in each case together with the information about the transmit power of the radio access points 101i in question, are reported to the localization unit 105.

Another Wi-Fi-based localization method is referred to here as Wi-Fi approximation. Wi-Fi approximation is performed on the basis of a received identifier of a radio access point 101i. When the identifier of a radio access point 101i is received, the localization unit 105 locates the terminal device 102 at the position of the radio access point 101i with which the identifier is associated. For this purpose, the identifier of a radio access point 101i is read out of the radio signals from the radio access point that have been received in the terminal device 102 that is to be located and it is then forwarded to the localization unit 105. Making use of the identifier, the localization unit 105 then requests the positions of the radio access point 101i from the central unit 103, and, on the basis of these positions, determines the location range of the terminal device that is to be located. In order to determine the position of the radio access point, the central unit 103 accesses the associations between the identifiers and the positions of radio access points 101i that are stored in the central unit 103.

Wi-Fi approximation entails greater imprecision in position determination than localization by lateration and localization by pattern recognition, since the identifier of a radio access point 101i can be received within a relatively large receiving area. For this reason, the two latter localization methods used in comparison to Wi-Fi approximation. An advantage of Wi-Fi approximation, however, is that only radio signals from just one single radio access point 101i have to be received. Consequently, Wi-Fi approximation can also be used with a low density of radio access points 101i in the area of a terminal device 102 that is to be located.

In addition to the localization unit 105 for Wi-Fi-based localization, terminal devices 102 that are operated in the systems described here optionally have additional units by which the terminal devices 102 can be located in a different manner. In particular, a terminal device 102 can comprise a satellite positioning module 107 with which the terminal device 102 can be located by GPS or another satellite-assisted navigation system. The satellite positioning module 107 comprises a receiver to receive the signals from navigation satellites. Furthermore, it has an evaluation unit that can determine the position of the terminal device 102 on the basis of the satellite signals. In the case of localization by GPS, optionally, assistance from additional information such as, for example, information about a cell in a mobile radio network in which the terminal device 102 that is to be located is currently present, can be used in a manner known to the person skilled in the art in order to improve the precision and availability. This is usually referred to as Assisted GPS (A-GPS). As a rule, the precision of the position determination in the case of localization by GPS is less than in the case of Wi-Fi-based localization by lateration or pattern recognition. Using GPS, a precision can be achieved that is the same as or slightly better than the precision that can be achieved with Wi-Fi approximation.

With the above-mentioned methods for Wi-Fi-based localization and satellite-assisted localization, several methods are available in the localization unit 105 in order to locate a terminal device 102, and these allow different levels of precision in the localization procedure. In order to locate the terminal device 102, prescribed criteria are employed to make a selection from the available localization methods. In this context, especially the availability of a Wi-Fi-based localization is ascertained and, if applicable, an available Wi-Fi-based localization method is selected. For this purpose, information is employed that can be present in the central unit 103 or that can be made available via the central unit 103. The localization unit 105 that carries out the localization of the terminal device 102 or else the central unit 103, for example, can be responsible for ascertaining the availability and for making the selection.

A first criterion for the selection of the localization method that is to be used is the number of radio access points 101i whose radio signals can be received in the terminal device 102 at the position that is to be located.

Particularly at the beginning of the localization procedure for a terminal device 102 at a certain position, a method for the localization of the position can first be determined on the basis of the number of radio access points 101i that are received in the terminal device 102. If radio signals are received at the position in question from at least one radio access point 101i, a Wi-Fi-based localization is an option. If radio signals are received from at least three radio access points 101i, the position can be determined on the basis of lateration or on the basis of pattern recognition. The selection of one of these localization methods can be made in a manner that will still be described below. When the radio signals are received from two radio access points 101i, then in one embodiment, a localization is performed on the basis of pattern recognition. In contrast, if a radio signal is received from only one radio access point 101i, then one embodiment provides for the localization on the basis of Wi-Fi approximation. As an alternative, however, in this case, a localization can be carried out by the satellite positioning module 107 if signals from a sufficient number of navigation satellites are received.

Often, the localization procedure is not terminated after the first determination of the position of a terminal device 102, but rather, the localization is continued in order to locate the terminal device, for example, while the terminal device user is en route to a destination. In view of this, it is provided that the availability of a localization method for a Wi-Fi-based localization is also ascertained for the surroundings of a previously determined position. This can be carried out after the first position determination as well as after subsequent position determinations. Ascertaining the availability of a Wi-Fi-based localization in the surroundings of an already determined position of a terminal device 102 is carried out, in turn, as a function of the number of receivable radio access points 101i, that is to say, the number of radio access points whose radio signals can be received in the terminal device 102. This number is estimated on the basis of information that is available in the central unit 103. The evaluation in this context is carried out in the central unit 103. By the same token, however, an evaluation can also be provided for in the localization unit 105 to which the required information can optionally be transmitted by the central unit 103.

In one embodiment, it is provided that the number of one or more positions in the surroundings of the previously determined position of the terminal device 102 is estimated. In one embodiment, these positions are at a prescribed distance from the position of the terminal device 102 that was previously determined by localization. Fundamentally, the estimate for a prescribed number of positions around the previously determined position of the terminal device 102 can be evaluated. The only positions taken into consideration are those that are accessible, that is to say, positions that are on a walking or driving surface and that can also be reached from the previously determined position. Areas that can be accessed and reached can be ascertained from map data that is present in the localization unit 105 and/or in the central unit 103.

In one embodiment, in order to determine the positions for the estimate of the number of receivable radio access points 101i, the direction of movement of the terminal device 102 is also taken into consideration, if this can be determined and if it has been determined. The direction of movement can be determined, for example, on the basis of a comparison of two previously determined positions of the terminal device 103. Taking into account the direction of movement of the terminal device 102, one or more positions can be selected for the estimate of the number of receivable radio access points 101i that are located at the prescribed distance from the most recently determined position of the terminal device 102 and that, based on these positions, are located in the direction of movement of the terminal device 102. By taking the direction of movement into consideration, the positions for which an estimate is made of the number of receivable radio access points 101i can be limited to a few positions, especially to one position.

Moreover, in another embodiment, the speed of the terminal device 102 can be determined and the distance of the examined positions to the previously determined position can be ascertained on the basis of the speed, whereby a greater distance is selected in the case of a higher speed. The speed can be determined, for example, in that the points in time at which the terminal device 102 reaches two previously determined positions is compared to the distance between these positions.

In one embodiment, in order to determine the number of radio access points 101i that are receivable at a given position, the number of radio access points 101i that are arranged around the position in prescribed surroundings is ascertained. The surroundings can correspond, for example, to a circle with a prescribed radius and with the position as the mid-point. In one embodiment, a number of receivable radio access points 101i results from the number of radio access points 101i that are registered in the central unit 103 with a position within the above-mentioned surroundings. In addition, optionally on the basis of the momentary transmit powers indicated by these radio access points 101i, it is possible to check whether the radio access points 101i are currently switched on, whereby in this case, only the switched-on radio access points 101i are taken into consideration for determining the number. In this manner, advantageously the only radio access points 101i taken into consideration are those from which radio signals can currently be received.

In addition to or as an alternative, a number of receivable radio access points 101i can be determined that corresponds to the number of different radio access points 101i from which radio signals are received via the above-mentioned measuring devices for detecting signal pattern data at positions in which radio signals can be received in the above-mentioned surroundings. This number can be determined in the central unit 103 on the basis of the signal pattern data that is reported by the radio access points 101i that are registered in the central unit 103 together with a position within the surroundings in question.

If the number of receivable radio access points 101i for all of the examined positions or at least for a prescribed minimum number of positions is higher than a prescribed minimum number, then the availability of a Wi-Fi-based localization is ascertained for the further position determination of the terminal device 102. In embodiments, the availability of Wi-Fi-based localization is ascertained when at least two or three radio access points 101i can be received at the examined position or positions. In this manner, the availability of Wi-Fi-based localization is only ascertained if it can be carried out with a high level of precision. As an alternative, the availability of Wi-Fi-based localization can also already be ascertained when only one radio access point 101i can be received at the position or positions. Here, it can be provided that in this case, the availability of Wi-Fi-based localization is only ascertained if the previously determined position was determined by a Wi-Fi-based localization, especially by lateration or pattern recognition. In this manner, Wi-Fi-based localization can be maintained, especially if just one radio access point 101i can be received only at individual positions, but for the rest, better Wi-Fi coverage exists in the area in which the terminal device 102 is located. Moreover, in the case of just one receivable radio access point 101i in the surroundings of the most recently determined position, the availability of Wi-Fi-based localization can be ascertained, even if satellite-assisted localization was not possible. In this manner, it is ensured that, if satellite-assisted positioning is not available, the terminal device 102 can be located by Wi-Fi-based localization, if this is possible.

As a result of ascertaining that Wi-Fi-based localization is available, especially the radio adapter 104 of the terminal device 102 is activated or an existing activation of the radio adapter 104 is maintained. On the other hand, if it is ascertained that Wi-Fi-based localization if not available, then the radio adapter 104 is switched off, as long as no data connection has been established via a single radio access point 101i. In the latter case, however, the search function of the radio adapter 104 can be switched off with which the radio adapter 104 determines receivable radio access points 101i by scanning Switching off the radio adapter 104 reduces the power consumption of the terminal device 102 and as a result, the charge of the battery that supplies the terminal device 102 with power can be prolonged.

As an alternative or in addition to the above-mentioned determination of the availability of Wi-Fi-based localization, the localization method to be used for the subsequent localization can be selected. As was also the case for the first localization, this localization method can be selected as a function of radio signals received in the terminal device 102 at the position that is to be located and/or optionally, already ahead of time, as a function of the information that is used for ascertaining the availability of Wi-Fi-based localization. As already described above, a localization is carried out on the basis of pattern recognition or on the basis of lateration when at least three receivable radio access points 101i are determined in the terminal device 102. In the case of two receivable radio access points 101i, pattern recognition can be carried out, and a Wi-Fi approximation is performed if it is ascertained that radio signals from just one single radio access point 101i are received.

When radio signals from at least three radio access points 101i can be received in the terminal device 102 that is to be located, a selection is made in order to determine whether to carry out the localization on the basis of pattern recognition or on the basis of lateration. Localization by lateration is highly precise when the received radio signals have been attenuated, at the most, only slightly by obstructions, or if their propagation has not been significantly impeded in some other way. If interference factors are present for the signal propagation, however, as a rule, the pattern recognition allows a localization with high precision, since interference leads to the “individuation” of the signal patterns. Therefore, in order to make the selection, it is determined whether Wi-Fi radio signals can propagate without any interference or at most with only slight interference in the area of the position of the terminal device 102 that is to be located. If this is ascertained, then a localization on the basis of lateration is carried out. Conversely, if the presence of interference is ascertained, then pattern recognition is selected as the localization method.

In order to check for the presence of interferences in the signal propagation, the signal strength of a radio signal from at least one radio access point 101i at a known position, which has been measured by a receiving unit, is compared to the expected signal strength. The signal strength can be derived from signal pattern data which is acquired in a manner described above using measuring vehicles, using other radio access points 101i or using positions known in some other way, and which encompasses the signal strength of receivable radio access points 101i. If a detection is stipulated that uses radio access points 101i or other stationary measuring unit that are present at known positions, the detection of the signal pattern data can be carried out on the basis of the evaluation that is to be carried out in response to a request by the central unit 103. As an alternative, signal pattern data that is stored in the database 106 of the central unit can be accessed.

In one embodiment, on the basis of the positions that are present for such signal pattern data, the position selected for the determination of the signal propagation conditions is the one that is closest to a previously determined position of the terminal device 102. For this purpose, the signal strength of one of the radio access points 101i that can be received there can be compared to the expected signal strength.

The expected signal strength is determined under the assumption of an essentially unimpeded signal propagation and as a function of the transmit power of the second radio access point 101i that the second radio access point 101i has reported to the central unit 103, and also as a function of the distance between the first and the second radio access points 101i. The distance is calculated on the basis of the positions of the first and second radio access points 101i, which are known and stored in the central unit 103. For the calculation, a suitable approximated mathematical description of the unimpeded signal propagation is used, which is familiar to the person skilled in the art. In particular, in order to determine the expected signal propagation, the so-called path loss, especially the path loss in free space can be used, which can be calculated in a generally known manner.

In one embodiment, lateration is selected as the localization method when the deviation between the measured signal strength and the expected signal strength does not exceed a prescribed threshold value, since in this case, a largely unimpeded visual connection for the radio signal propagation between the radio access points 101i can be assumed. In contrast, if the deviation is greater than the threshold value, then pattern recognition is selected as the localization method.

In another embodiment, the signal strengths of radio signals from several second radio access points 101i that have been measured at the selected known position are compared to expected signal strengths, which are each calculated in the manner described above. In this embodiment, lateration is only selected for purposes of locating the terminal device if the deviation for all of the radio signals or at least for a prescribed minimum number of radio signals is not greater than the threshold value. If this is not the case, then pattern recognition is selected as the localization method.

In other embodiments, comparisons between expected and measured signal strengths for one or more radio signals can also be carried out for several known positions in the surroundings of a previously determined position of the terminal device. Here, it can be provided that lateration is only selected as the localization method to be used if unimpeded visual connections for the radio signal transmission between the radio access points 101i have been ascertained for all or for several radio access points 101i on the basis of the criteria described above.

Although the techniques described herein have been described in detail in the drawings and in the presentation given above, the presentations are merely illustrative and provided by way of example, and should not be construed in a limiting manner. In particular, the techniques described herein are not limited to the explained embodiments. The person skilled in the art can glean additional variants of the techniques described herein and their execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the techniques and steps employed.

1-15. (canceled)

16. A method for the localization of a terminal device by a localization unit, the method comprising:
locating the terminal device in a radio network-based manner via the localization unit, on the basis of radio signals sent and/or received in a radio network;
selecting the radio network-based localization as:
a function of an evaluation of radio signals from at least one radio access point of the radio network that have been detected in the vicinity of the terminal device by at least one receiving unit; and/or
a function of information about installation sites of radio access points of the radio network;
wherein the vicinity is determined in such a way that it surrounds a position of the terminal device that has previously been determined at least by approximation; and
wherein this position that has been determined by approximation is ascertained by a central unit that can be connected to the terminal device and/or to the radio access point, based on an identifier of a radio access point situated within the radio range of the terminal device.

17. The method according to claim 16, wherein the localization by the localization unit is only activated or continued if the number of radio access points whose radio signals are detected in the receiving unit and/or the number of radio access points with an installation site in the vicinity of the terminal device exceeds a prescribed minimum number.

18. The method according to claim 16, wherein on the basis of the evaluation of the radio signals, the method comprising estimating the number of radio access points whose radio signals can be received at a future position of the terminal device.

19. The method according to claim 16, wherein the direction of movement of the terminal device is ascertained, and the vicinity is determined as a function of the ascertained direction of movement of the terminal device.

20. The method according to claim 16, wherein the radio signals are detected in the receiving unit on the basis of an evaluation that is to be performed.

21. The method according to claim 16, wherein, in order to locate the terminal device, the radio access points whose radio signals can be received in the terminal device are determined by a radio adapter of the terminal device, and wherein the determination of such radio access points is deactivated by the radio adapter if the localization by the radio signals has not been activated or continued.

22. The method according to claim 21, wherein the localization methods comprise a lateration in which the distances to radio access points are determined on the basis of the signal strength of radio signals received in the terminal device from the radio access points, and they comprise a localization on the basis of comparisons between the detected signal pattern and reference signal patterns.

23. The method according to claim 21, wherein the evaluation of the radio signals from a radio access point that have been received by the receiving unit comprises a comparison of the signal strength received in the receiving unit to the signal strength that is expected on the basis of the transmit power of the radio access point.

24. The method according to claim 23, wherein a localization by lateration is carried out when a deviation between the detected signal strength and the expected signal strength does not exceed a prescribed threshold value.

25. The method according to claim 22, wherein the transmit power of the radio access point is determined on the basis of the transmit power data that is representative of the transmit power and that is reported by the radio access point.

26. The method according to claim 16, wherein the at least one receiving unit is a first radio access point, whereby the first radio access point can be operated in a first mode of operation in which it serves as the access point to a communication network, and wherein the first radio access point can be operated in a second mode of operation in which radio signals from other radio access points can be detected.

27. The method according to claim 16, wherein the radio access points are configured as Wi-Fi access points and/or as a radio access points to a mobile radio network.

28. A system for the localization of a terminal device, comprising:
a localization unit, at least partially comprising hardware logic, that is configured to:
locate the terminal device on the basis of radio signals sent and/or received in a radio network;
select localization on the basis of:
the radio signals as a function of an evaluation of radio signals from at least one radio access point that have been detected in the vicinity of the terminal device by at least one receiving unit; and/or
the radio signals as a function of information about installation sites of radio access points of the radio network;
wherein the vicinity is determined in such a way that it surrounds a position of the terminal device that has previously been determined at least by approximation; and
a central unit that can be connected to the terminal device and/or to the radio access point, wherein the central unit is configured to determine the position that is determined by approximation based on an identifier of a radio access point situated within the radio range of the terminal device.
